(19) United States
(12) Patent Application Publication
(10) Pub. No.: US 2009/0026306 A1
(43) Pub. Date: Jan. 29, 2009

(54) METHOD AND APPARATUS FOR DISPENSING PACKAGING; METHOD AND APPARATUS FOR GUARDING MACHINERY

(76) Inventors: Mark Kempster, Welwyn (GB); Theo Thomas, Barton-le-Clay (GB)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 11/816,626

(22) PCT Filed: Jan. 11, 2006
(86) PCT No.: PCT/GB06/00098

§ 371 Date: Mar. 3, 2008

(30) Foreign Application Priority Data
Feb. 18, 2005 (GB) 0503383.2
Nov. 3, 2005 (GB) 05 22447.2

(51) Int. Cl. B65H 16/02; B26F 3/02

(52) U.S. Cl. 242/593; 225/46

(57) ABSTRACT

A roll of paper (18) is stored in a container (16). Paper is drawn from the internal wrapping of the roll (18) out through an opening (20) to form a loose spiral (22) having overlaps of three thicknesses of paper. The paper is pulled by an operator. When the desired length has been pulled the paper is pulled down to cause a lever (24) to be pulled down to expose a serrated knife (26) which then cuts off the paper.

The present invention relates to a packaging dispenser arrangement, a method of dispensing packaging, a machinery guard arrangement and a method of guarding machinery. The present invention is particularly although not exclusively applicable to such arrangements for use in producing paper packaging.

Various prior dispensers of paper or paper like material are known but none of these relate specifically to packaging. For instance, U.S. Pat. No. 5,762,286 discloses a toilet roll dispenser, US 2003132237A discloses a wet wipe dispenser, U.S. Pat. No. 5,715,971 discloses a paper towel dispenser, U.S. Pat. No. 5,577,634 also discloses a paper towel dispenser, U.S. Pat. No. 5,273,184 discloses a roll product dispenser, U.S. Pat. No. 5,246,137 discloses a sheet dispenser, U.S. Pat. No. 5,219,126 discloses a sheet dispenser, U.S. Pat. No. 5,211,308 discloses a paper dispenser, U.S. Pat. No. 5,346,064 discloses a paper towel dispenser, CA 1,284,786 discloses a sheet dispenser, SE 7809911 discloses a paper roll dispenser and U.S. Pat. No. 2,864,495 also discloses a paper product dispenser. However, none of these dispensers relates to packaging. Furthermore, a single sheet only is removed from the store or roll.

According to one aspect of the present invention a packaging dispenser arrangement includes a roll of packaging wound around an axis, the packaging being arranged to be withdrawn from the roll in the direction of extent of the axis.

The axis may be horizontal or vertical or anywhere between.

According to another feature of the present invention a method of dispensing packaging comprises withdrawing packaging from a roll of packaging wound around an axis by withdrawing the packaging in the direction of extent of the axis.

According to another aspect of the present invention a machinery guard arrangement includes a supply of material, a guard that, in normal use, at least partially conceals a device arranged to have an effect on the material, the material being arranged to pass the guard in a first position of normal use, the supply of material being manually movable from a normal direction to an angle to that normal direction such that the material causes the guard to move relative to the device to a second position to reveal the device with the revealed device then being arranged to have an effect on the material.

According to a further aspect of the present invention a method of guarding machinery comprises causing a supply of material to pass a guard that conceals a device arranged to have an effect on the material when not guarded and altering the direction of the material manually such that the guard is moved clear of the device with the device then having an effect on the material.

Further features are defined in the claims appended hereto.

When withdrawn from the container, the end edge of the roll may be at an angle of less than 45° with respect to the axis of the roll and may be less than 30° or 35° or 30° or 25° or more than 5° or 10° or 20°. The axially facing edge of the roll, when in the roll, may be at an angle to the axis of the roll of more than 45° or 55° or 65° or 70° or less than 85° or 80°.

The present invention can be put into practice in various ways but one embodiment will now be described by way of example and with reference to the accompanying drawings, in which:

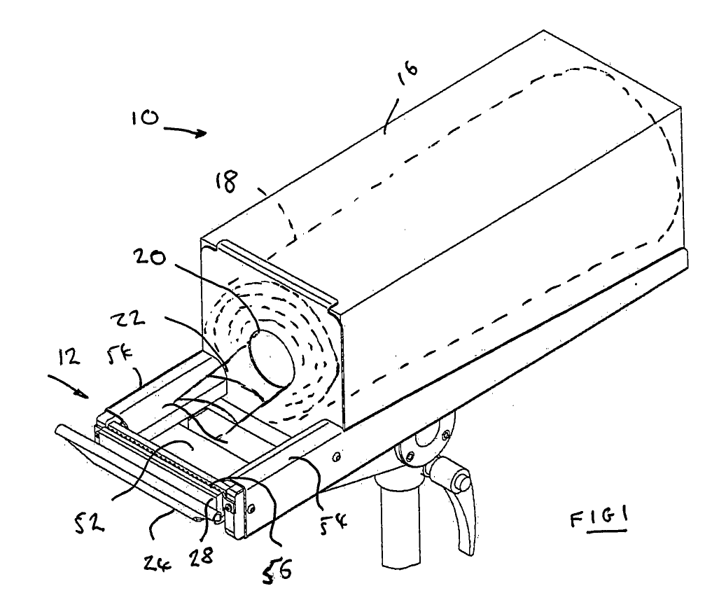

FIG. 1 is a front perspective view of a packaging device 10;

FIG. 2 is a side view of FIG. 1;

FIG. 3 is a plan view of FIG. 1;

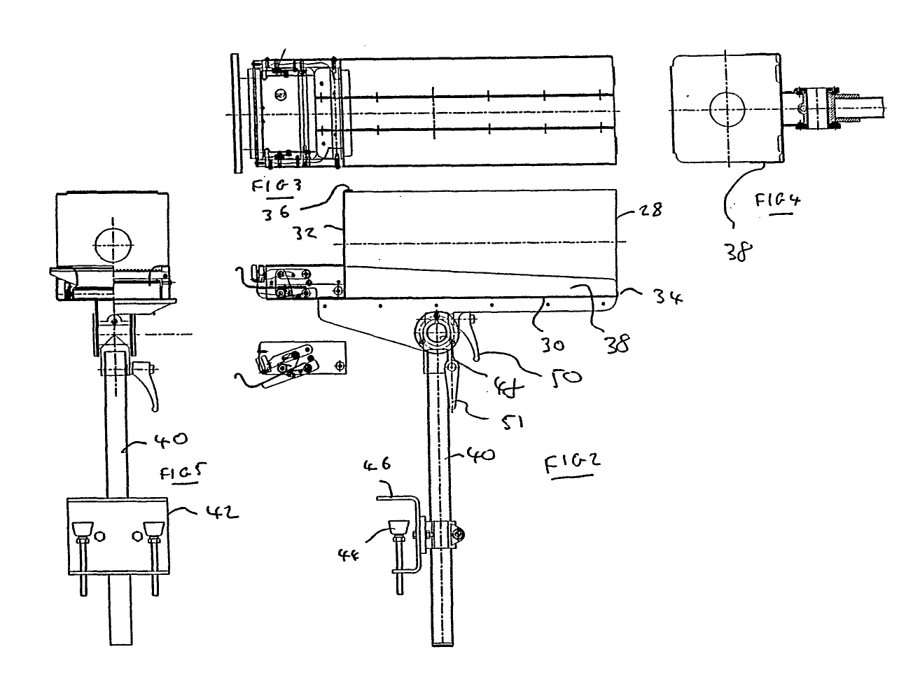

FIG. 4 is a rear view of FIG. 1;

FIG. 5 is a front view of FIG. 1;

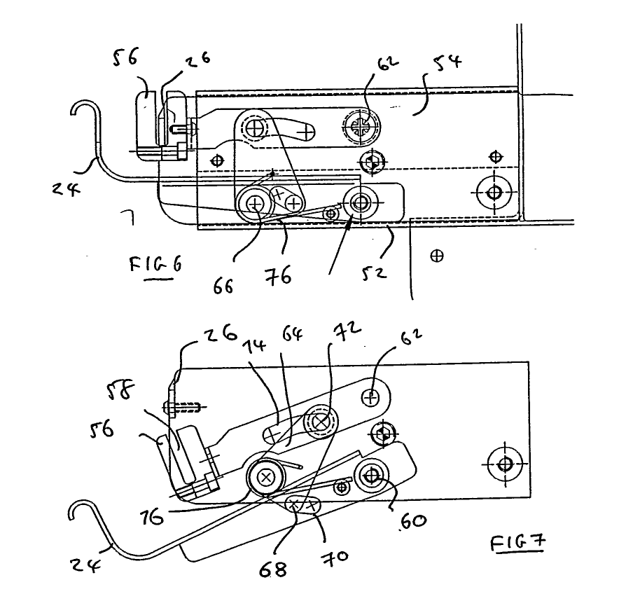

FIG. 6 is a side view of a paper cutter 12 in an inoperative position;

FIG. 7 is a view of the cutter 12 in an operative position;

FIG. 8 is a right side view of a drive mechanism 14 that can be used to draw paper out of a container 16;

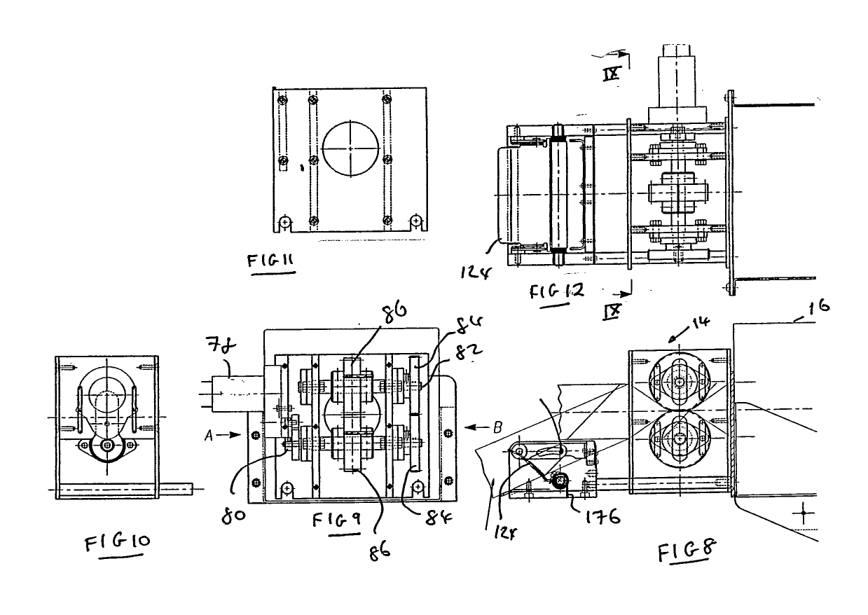

FIGS. 9, 10, 11 and 12 are respectively, a section on ix-ix, left side view, front view and plan view;

FIG. 13 is a side view of a second embodiment of a packaging device showing a side view of a power feed;

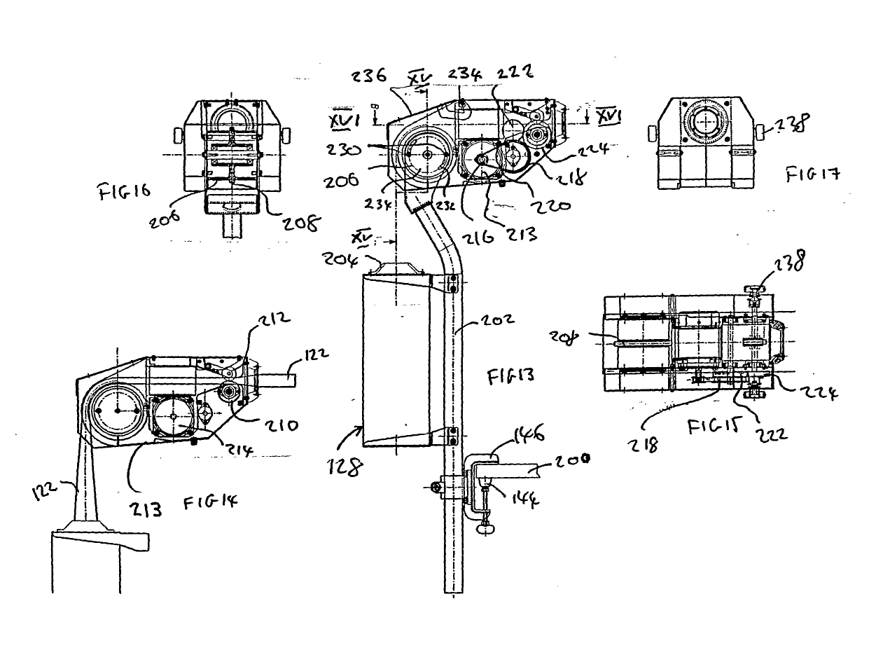

FIG. 14 is a scrap view showing in detail the path of the paper in the power feed;

FIGS. 15 and 16 are, respectively, sectional views along the lines XV-XV and XV1-XV1, and

FIG. 17 is a front view of the power feed.

As shown in FIG. 1, a roll of paper 18, which may be without a core, is stored in the container 16. Paper is drawn from the internal wrapping of the roll 18, out through an opening 20 to form a loose spiral 22 having overlaps of three thicknesses of paper. The overlap is assisted as a result of the friction occurring between adjacent surfaces of layers in the roll. The paper is pulled by an operator. When the desired length has been pulled the operator pulls the paper down to expose a serrated knife 26 which then cuts off the paper.

A lever 24 then springs back into the position shown leaving a length of spiral between the knife and the opening for the operator to pull and cut off when next the packaging is required.

The paper can be supplied as a roll which, when replacement is required, can be slid in from the rear end of the container. Alternatively, the container can be supplied in a box 28, which as shown in FIG. 2, can be dropped onto the base 30 with the front of the container abutting a wall 32 having the opening 20 and with the rear base of the container abutting a lip 34. The top of the wall 32 has a ledge 36 which prevents the front of the container from rising up. Side walls 38 prevent transverse movement of the container. Thus the container is securely held and may be easily replaced. The container may have an open front wall or an opening in the front wall to correspond with the opening 20. The front wall or opening in the container may be made by an operator detaching part of the container. The container may be made of cardboard. The front wall 32 may have a cone extending towards the cutter and tapering inwardly towards the cutter.

In use, the container will be fastened to a work bench. This is effected by a shaft 40 extending down the base 30. As shown in FIG. 5, the shaft 40 has a plate 42 slidably mounted thereon with the plate 42 including a pair of clamps 44 which can hold the device in place at the desired elevation above the work surface of the base by holding a work surface between the clamps 44 and an upper facing surface 46 of the plate. Thus, in one arrangement the device could be clamped to the rear of a work surface with the container projecting forwardly over and spaced from the work surface. Accordingly the space on the work surface beneath the container remains free to use.

Whilst the container is shown with its elongate axis being horizontal, this angle can be altered. The base 30 is connected to the shaft 40 by a pivot bolt 48. A quick release and lock lever 50 is provided to allow angular adjustment such that the axis can extend at 10°, 20° or 30° or any desired angle to the horizontal. A further quick release lock lever 51 allows the container to be swivelled on the shaft 40.

In the embodiment shown, the outlet of the opening 20 is approximately one third of the outside diameter of a new roll. The outside diameter of a new roll may be 150 mm and the roll may have a length of 375 mm. In another arrangement, the roll has a diameter of 220 mm with the opening 20 being 127 mm in diameter. The opening 20 may be 20, 30, 40, 50, 60 or 70 mm in diameter.

A shelf 52 extends from the front of the container to the cutter 12 at a lower elevation than the cutter. Opposing sides 54 of the shelf extend upwardly and support the cutter at their free end.

When paper is being drawn out of the container the spiral passes over the shelf 52 and over the top of a guard 56. The guard 56 extends to a greater height than the knife 26 and to the front and rear of the knife along the complete length of the knife by an upwardly extending slot 58 of the guard substantially enclosing the knife.

As shown in FIGS. 6 and 7, the lever 24 can be urged downwardly by the paper being pulled downwardly out of the device to expose the knife and cut the paper.

The lever 24 is mounted on a pivot 60. The guard 56 is mounted on a pivot 62. The guard and lever are connected at both sides by an operating plate 64 which is itself mounted about a pivot 66. A pin or roller 68 fast with the plate extends through a slot 70 in the lever 24 and another pin or roller 72 fast with the plate 64 extends through an arcuate slot 74 in the guard 56.

Downwards movement of the lever in an anticlockwise direction pulls the plate 64 down in a clockwise direction with the pin 68 travelling along the slot 70 from the right to the left hand side. Clockwise movement of the plate 64 pulls the guard down in an anticlockwise direction with the pin 72 travelling from the right to the left hand side of the slot 74. Thus the blade is exposed as shown in FIG. 7. Movement in the opposite direction returns the lever and guard to the position shown in FIG. 6. The plate 64, and thus the guard and lever, is biased to the position shown in FIG. 6 by a pair of torsion springs 76 mounted on either side about the pivot 66.

In a modified embodiment the spiral can be pulled out of the container by a pair of driven members upstream of the knife, as shown in FIGS. 8 to 12.

A motor 78 drives a lower shaft 80. The shaft 80 extends across the machine to drive an upper shaft 82 via meshing gears 84 connected to both shafts. The motor can be stopped and started by an operator.

At the centre of each shaft a pair of members 86 rotate to cause a spiral between them to be pulled out of the container and to drive the spiral from the members 86. The members 86 may have resilient outer surfaces which may trap a spiral between them and may be compressed at their adjacent region. Alternatively or additionally the members may have uneven external surfaces, such as a cog, which may each pass within the area swept the other member during rotation in order to bunch up the spiral or help connect the spiral or help the spiral maintain the relationship between the layers in the spiral or any combination thereof.

Although the axis of the roll is shown as being horizontal in another embodiment the axis could be vertical with packaging being drawn downwards and the device may be adjustable such that it can be moved to the axis being vertical, for instance from a previous position shown in which it is horizontal.

Like parts in FIGS. 13 to 17 will be given the same number prefixed by the number 1.

As shown in FIG. 13, the container or box 128 is fastened to a bench 200 as previously described in relation to FIGS. 1 to 12. In the embodiment the box 128 is mounted, with the winding axis of the roll vertical, on a bar 202. Paper is packed in the box as previously described and the outlet of the box is in the form of an inwardly and upwardly converging cone 204. The paper spiral 122 is fed vertically upwards from the box and around a free running roller 206 having a centrally located circumferentially extending rib 208. The paper leaves the roller 206 in a horizontal direction and passes between a lower driven roller 210 and an upper idler roller 212 before passing out of a housing 213.

The rib 208 on the roller 206 serves to maintain the spiral in an expanded form. If the rib 208 were not present then there may be a tendency for the spiral to collapse flat around the roller thereby decreasing the volume and reducing the effectiveness of the packing. At the sides of the roller the packing may be guided to maintain the packaging in the central region. Alternatively or additionally, the packaging may not need guides or may be guided centrally by the rib on the roller.

The driven roller 210 is powered by a motor 214 which drives a first small gear 216 and a second, spaced large gear 218 via a chain 220. The gear 218 is mounted on the same shaft as a large cog 222 which meshes with a small cog 224. The small cog 224 is mounted on the same shaft as the driven roller 210. Thus powering the motor causes the chain to drive the gear 218 and the cog 222 which in turn causes the cog 224 and roller 210 to rotate.

In the position of the cogs shown the feed rate of paper from the housing will be in the region of 76 m/min. If the cogs 222 and 224 are reversed from the position shown then the feed rate will increase to around 92 m/min for a constant rate of rotation of the gear 218. Thus the same motor at the same speed can be used to drive the paper at different speeds.

The idler roller 212 is mounted at the free end of a swinging arm 226. The arm 226 is pivotally mounted on an opposed end and is biased by a spring 228 such that the roller 212 is biased towards the driven roller to trap the paper between the rollers 210 and 212.

The housing 213 is pivotally mounted on the bar 202 and can move through approximately 30° to direct the feed from the horizontal position shown in FIG. 13 at an angle down towards the work bench 200. The adjustment is effected by relaxing bolts 230 that hold the housing on an arcuate mount 234 at the top of the bar 202 and rotating the housing in a clockwise direction with the bolts moving through arcuate slots 232 in the mount 234 and then tightening the bolts 230 again when the desired angle is reached. That angle may have the bolts located at the ends of the slots or at a position between the ends.

The paper is loaded into the machine, at the start of a new roll of packaging, by pivoting a cover 236 upwardly about a pivot 234. The paper is then fed around the ribbed roller and then passed to the driven and idler roller. Handles 238 on either side of the housing can then be rotated manually to manually rotate the driven roller and thus feed the paper through the rollers.

Paper may be arranged to be fed at a length determined by an operator. For instance an operator may actuate a foot switch that causes paper feed with release of the foot causing the feed to stop. Alternatively or additionally, the feed may be in predetermined lengths (which predetermined lengths may be able to be altered) by an operator activating a switch.

Detachment of the fed paper from the housing may be effected automatically, such as a blade (not shown) sweeping across the outlet of the housing. Alternatively or additionally, detachment may be effected by an operator actuating a switch or by the operator pulling the paper sideways relative to the outlet as described in relation to FIGS. 1 to 12.

After a length of packaging has been detached the drive may be arranged to automatically withdraw another length of the packaging such that the operator does not have to initiate a further withdrawal procedure after having used the previously detached length of packaging. In this way packaging time is reduced.

Any features of FIGS. 1 to 12 and the associated description may be combined with any features of FIGS. 1 to 16 and the associated description and vice versa.

The paper withdrawn from may be recycled paper. The spiral of paper, which may be in tube form, may be used to fill voids in containers to cushion items in the containers. When the spiral is rolled into a coil the material may be able to support heavy objects, for instance up to 100 kg in weight.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiments). The invention extends to any novel one, or any novel combination, of the features disclosed in this specification (including any accompanying claims, abstract and drawings), or to any novel one, or any novel combination, of the steps of any method or process so disclosed.

1-70. (canceled)

71. A packaging dispenser arrangement including a roll of packaging wound around an axis, packaging being arranged to be withdrawn from the roll in the direction of extent of the axis.

72. An arrangement as claimed in claim 1 in which the packaging is arranged to be withdrawn with at least one winding of packaging overlapping at least one adjacent winding of packaging over at least part of its extent.

73. An arrangement as claimed in claim 2 in which the packaging is arranged to be withdrawn with at least one winding of packaging overlapping at least two other windings of packaging over at least part of its extent.

74. An arrangement as claimed in claim 2 in which the packaging, when withdrawn and out of the dispenser is arranged to have at least one winding of packaging overlapping at least one adjacent winding of packaging.

75. An arrangement as claimed in claim 1 in which a side of the roll that faces coaxially when in the roll also faces at least partially in the axial extent when withdrawn from the roll.

76. An arrangement as claimed in claim 5 in which the side of the roll that faces axially when in the roll faces the axial extent at an angle of more than 45° to the axial extent when withdrawn from the roller.

77. An arrangement as claimed in claim 1 in which the packaging is arranged to be withdrawn from the roll from an inner winding of the packaging.

78. An arrangement as claimed in claim 1 in which the device is arranged to be detachably mounted on a support.

79. An arrangement as claimed in claim 8 in which the device is adjustable whereby the angle of inclination of the axis is arranged to be adjustable when the device is mounted on a support of, for instance, more than 10° or less than 50° or more than 20° or less than 40°.

80. An arrangement as claimed in claim 8 in which the height of the packaging is arranged to be adjustable when the device is mounted on a support.

81. An arrangement as claimed in claim 8 in which the axis of the packaging is arranged to be adjustable when the device is mounted on a support about an axis transverse to the axis of the packaging.

82. An arrangement as claimed in claim 1 in which the withdrawn packaging is arranged to pass partially around a rotatable member having at least one projection from the radially extending peripheral surface.

83. An arrangement as claimed in claim 12 in which the at least one projection comprises a radially extending rib.

84. An arrangement as claimed in claim 1 including drive means arrangement, in use, to pull the packaging from the roll.

85. A packaging dispenser arrangement including a roll of packaging wound around an axis, packaging being arranged to be withdrawn from the roll in the direction of extent of the axis in which the end edge of the roll that is withdrawn from the dispenser is at an angle of less than 45° to the axial extent when withdrawn from the roll and is arranged to face at least partially in the radial direction with respect to the axis of the roll when withdrawn from the roll.

86. A packaging dispenser arrangement including a roll of packaging wound around an axis, packaging being arranged to be withdrawn from the roll in the direction of extent of the axis and in which the roll is held in a container and the packaging is arranged to be withdrawn from the roll in the container.

87. A packaging dispenser arrangement including a roll of packaging wound around an axis, packaging being arranged to be withdrawn from the roll in the direction of the extent of the axis, including a separator arranged to detach packaging when the desired length of packaging has been withdrawn and a guard for the separator, the guard being movable relative to the separator in order to expose the separator by a force exerted by the packaging.

88. An arrangement as claimed in claim 17 in which the force exerted by the packaging is also arranged to effect the separation.

89. An arrangement as claimed in claim 17 in which the relative movement between the guard and separator is effected by an operating lever that is arranged to be moved as a result of a force exerted by the packaging.

90. A packaging dispenser arrangement including a roll of packaging wound
around an axis, packaging being arranged to be withdrawn from the roll in the direction of the extent of the axis, including drive means arranged, in use, to pull the packaging from the roll.

91. An arrangement as claimed in claim 20 in which the drive means is located downstream from the packaging and is spaced from the packaging.

92. An arrangement as claimed in claim 20 in which the rate of feed of the withdrawn packaging is adjustable.

93. An arrangement as claimed in claim 22 in which the rate of feed of the withdrawn packaging is adjustable by reversing the orientation of different sized cooperating drive parts.

94. An arrangement as claimed in claim 20 in which the amount of packaging withdrawn during a withdrawing operation is the same for successive operations or determined by an operator or both.

95. An arrangement as claimed in claim 20 in which, after detachment of a length of withdrawn packaging the drive means are arranged to automatically withdraw more packaging.

96. A method of dispensing packaging comprising withdrawing packaging from a roll of packaging wound around an axis by withdrawing the packaging in the direction of extent of the axis.

97. A method as claimed in claim 26 comprising withdrawing the packaging with at least one winding from the roll overlapping another winding from the roll.

98. A method as claimed in claim 27 comprising withdrawing the packaging with at least three windings from the roll overlapping each other along at least one extent of the roll.

99. A method as claimed in claim 26 comprising the layers overlapping each other as a result at least in part of the friction occurring between one winding and an adjacent winding.

100. A method as claimed in claim 26 comprising withdrawing packaging from an inner winding of the roll.

101. A method as claimed in claim 26 comprising separating a length of packaging by pulling a length of the packaging against a separator.

102. A method of dispensing packaging comprising withdrawing packaging from a roll of packaging wound around an axis by withdrawing the packaging in the direction of extent of the axis through a guide of decreasing cross-sectional area.
